(19) United States
(12) Patent Application Publication
(10) Pub. No.: US 2008/0301913 A1
(43) Pub. Date: Dec. 11, 2008

(54) Device for preventing tangling of a coiled cord

(76) Inventor: James C. Alfarone, Houston, TX (US)

Correspondence Address: Benjamin Aaron Adler;ADLER & ASSOCIATES, 8011 Candle Lane, Houston, TX, 77071, US

(21) Appl. No.: 12/156,065

(22) Filed: May 29, 2008

Related U.S. Application Data
(60) Provisional application No. 60/933,716, filed on Jun. 8, 2007.

(51) Int. Cl. F16G 11/00

(52) U.S. Cl. 24/115 R

(57) ABSTRACT

Provided herein are devices for preventing tangling of a coiled cord, for example, a telephone cord. The devices comprise an elongate, flexible cord with dimensions less than the interior dimensions of the coiled cord that has a first and second end and means for rounding the first and second ends of the elongate, flexible cord, for example, caps. Also provided is a system comprising the device and means for fastening the device to the coiled cord.

### CROSS-REFERENCE TO RELATED APPLICATION

This nonprovisional application claims benefit of priority under 35 U.S.C. §119(e) to provisional U.S. Ser. No. 60/933,716, filed May 31, 2007, now abandoned.

### BACKGROUND OF THE INVENTION

1. Field of the Invention

The present invention relates to devices effective to prevent tangling of coiled cords. More specifically, the present invention relates to devices insertable and slidable within coiled cord.

2. Description of the Related Art

The trend today is for communication equipment and other electric opera equipment or appliances to be cordless. However, telephones and other devices, such as electric shavers, clippers, and microphones attachable to recording equipment, have a coiled cord attached thereto are available and are utilized in offices and in the home. Coiling the cord provides a smaller footprint while allowing for a greater stretching distance in which to use the equipment to which it is attached.

Constantly using and replacing the equipment, such as removing and replacing a telephone handset or an electric shaver onto a base, causes the coiled cord to twist around itself and become tangled which limits the useful distance of the cord. It is common practice to untangle the cord by allowing, for example, the telephone handset to dangle from the coiled cord and rotate freely until untwisted. However, as is well known, this is not a permanent solution.

U.S. Pat. No. 4,679,234 discloses an attachment for a telephone cord that prevents tangling. The attachment is a plate-like device which is both attached to the coils and must have part of the coils wound through the plate. Also, the plate extends beyond the coil to provide stability for the cord lying on a surface or through the hanging weight thereof. For longer cords, two or more attachment devices are required. Although the attachment plate is formed as a single piece, installation requires both insertion of at least one attachment plate within the coil and weaving coils through the attachment.

Thus, there is a recognized need in the art for improved, simplified, low cost, and easy to install devices for preventing a coiled cord from tangling around itself. More specifically, the prior art is deficient in devices insertable and movable within the coil of a cord that are effective to prevent its tangling. The present invention fulfills this long-standing need and desire in the art.

### SUMMARY OF THE INVENTION

The present invention is directed to a device effective for preventing tangling of a coiled cord. The device comprises an elongate, flexible cord with dimensions less than the interior dimensions of the coiled cord and having a first and second end and means for rounding the first and second ends of the elongate, flexible cord.

The present invention also is directed to a related device effective for preventing tangling of a coiled telephone cord. The device comprises an elongate, flexible cord with a first end and a second end and having a length and outer dimensions less than a length and internal diameter of the coiled telephone cord and rounded caps having an internal diameter sufficient to encase the first and second ends of the elongate, flexible cord.

The present invention is directed further to a system effective for preventing tangling of a coiled cord. The system comprises the devices described herein and means for fastening the device to the coiled cord.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others which will become clear are attained and can be understood in detail, more particular descriptions and certain embodiments of the invention briefly summarized above are illustrated in the appended drawings. These drawings form a part of the specification. It is to be noted, however, that the appended drawings illustrate preferred embodiments of the invention and therefore are not to be considered limiting in their scope.

FIG. 1 is a side-view of one embodiment of a device for preventing tangling of a coiled cord.

FIGS. 2A-2B illustrate the placement of the device within a phone cord less than 4 feet in length (FIG. 2A) and greater than 4 feet in length (FIG. 2B).

### DETAILED DESCRIPTION OF THE INVENTION

As used herein, the term “a” or “an”, when used in conjunction with the term “comprising” in the claims and/or the specification, may refer to “one,” but it is also consistent with the meaning of “one or more,” “at least one,” and “one or more than one.” Some embodiments of the invention may consist of or consist essentially of one or more elements, method steps, and/or methods of the invention. It is contemplated that any method or composition described herein can be implemented with respect to any other method or composition described herein.

As used herein, the term “or” in the claims refers to “and/or” unless explicitly indicated to refer to alternatives only or the alternatives are mutually exclusive, although the disclosure supports a definition that refers to only alternatives and “and/or.”

In one embodiment of the present invention there is provided a device effective for preventing tangling of a coiled cord, comprising an elongate, flexible cord with dimensions less than the interior dimensions of the coiled cord and having a first and second end; and means for rounding the first and second ends of the elongate, flexible cord.

In this embodiment the elongate flexible cord may be a flat cord or an O-ring cord. The elongate flexible cord comprises plastic tubing, a plastic rod, a rubber cord, or a steel wire. Also, the elongate, flexible cord may have a length of about 2 feet to about 6 feet. In addition, the means for rounding the ends of the elongate, flexible cord may be rounded caps having an internal diameter sufficient to encase the first and second ends thereof. The rounded caps may be vinyl. An example of a coiled cord is a telephone cord.

Related to this embodiment is a device effective for preventing tangling of a coiled telephone cord, comprising an elongate, flexible cord with a first end and a second end and having a length and outer dimensions less than a length and internal diameter of the coiled telephone cord; and rounded caps having an internal diameter sufficient to encase the first and second ends of the elongate, flexible cord. In this related embodiment the elongate, flexible cord and the caps may be as described supra.

In another embodiment of the present invention there is provided a system effective for preventing tangling of a coiled cord, comprising the device described supra; and means for fastening the device to the coiled cord. In this embodiment the fastening means may be a plastic tie. Also, the coiled cord may be as described supra.

Provided herein are devices and systems effective to prevent a coiled cord from tangling or twisting around itself as the equipment to which it is attached is used. The device has an elongate shape and a flexible structure and is inserted easily by hand through the coils of the cord. The device upon placement remains slidable through the length of cord. When the cord is hanging or otherwise not in use, the device remains positioned within the coil conforming to the shape formed by the cord, such as a U-shape, substantially along the central portion of the cord.

Without being held to theory, it is contemplated that, the device is sufficiently flexible to conform to the shape of the coiled cord whether in an unstretched or stretched configuration, but not sufficiently flexible to allow the coils to entangle with one another. If the coiled cord is stretched, the device conforms to the lengthened configuration. The device may be slidable within the coiled cord. Alternatively, the device may be fastened or tied to the cord and held in place.

The device structure is elongate with a flat cord or O-ring cord configuration. For example, the device may have a length up to about 6 ft, preferably about 2 ft to about 6 ft. The width and thickness of the flat cord or the diameter of the O-ring cord must have a dimension sufficiently smaller than the interior diameter of the coiled cord such that the device can be positioned or inserted easily therein and slide easily within the coiled cord. The device may comprise plastic tubing, plastic rods, rubber cords, or steel wire or any other flexible material that can be made with an appropriate width or diameter.

The device comprises a means for rounding the ends of the elongate, flexible cord, such as, but not limited to, caps, for example, vinyl caps. The caps may be rounded to facilitate placement and to prevent the edges of the device from catching on the coils when inserting or positioning the same or when the device slides within the coiled cord. If the device is a flat cord, it may be manufactured as a single piece with the caps attached or fixed thereto. If the device is an O-ring cord, the caps may be attached by a user thereof. Attachment is effected by placing a drop of glue, superglue or other suitable adhesive known and standard in the art in the interior of the caps and placing them over the ends of the O-ring cord to affix them thereto. The inner diameter of the caps that are placed or affixed on the ends of an O-ring cord depend upon the outer diameter of the O-ring cord. For example, but without being limiting, caps effective to cap an O-ring cord with outer diameter of about 0.177 in. to about 0.148 in. may have an inner diameter of about 0.187 in. to about 0.148 in.

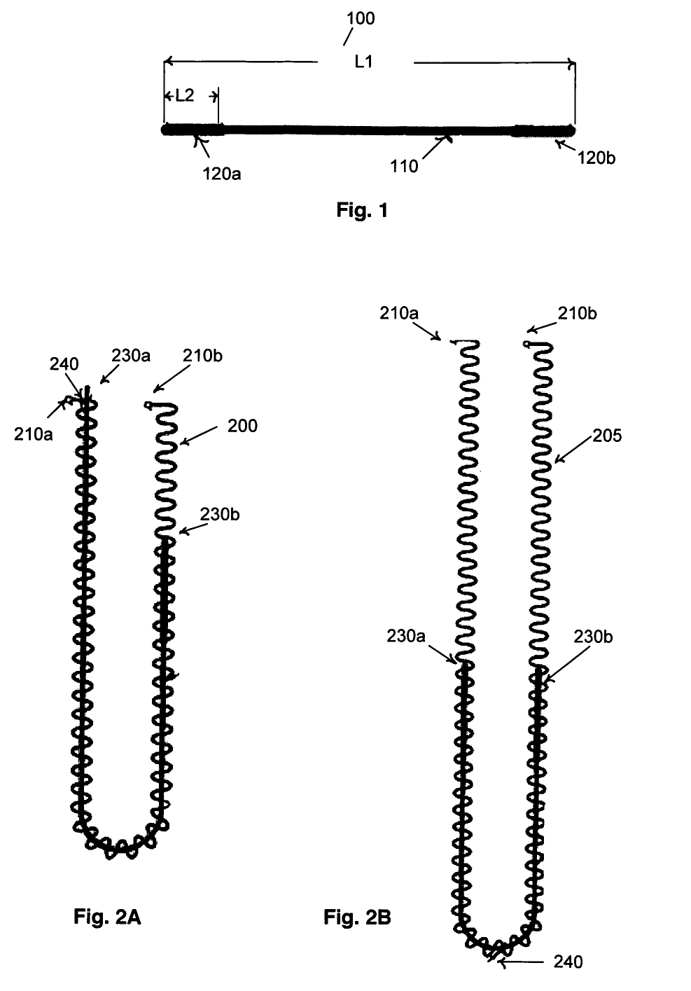

Referring to FIG. 1, an O-ring cord device or COBRA™ is illustrated. The device 100 comprises a flexible O-ring cord 110 having length L1. L1 may be about 2 ft. to about 6 ft. in length. Caps 120a,b having length L2 are affixed to each end of the O-ring cord. L2 may be about 2 in. to about 4 in.

The device may be used in any coiled cord, such as, but not limited to, a telephone cord, a cord attached to an electric shaver, to electric clippers, or to a microphone. Particularly, the device, referred to herein by Applicant's designation COBRA™, is effective to control a coiled telephone cord on either a stand alone or wall-mounted telephone. When attached to the telephone base and to the handset, the coiled telephone cord conventionally conforms to a U-shape when not in use. The elongate, flexible device remains at the bottom of the U-shape cord and conforms to the cord's shape. The resulting U-shape of the COBRA™ maintains a uniform distance between the two sides of the U of the cord thereby effectively preventing contact and subsequent tangling of the coils.

Optionally, the device may be tied or fastened to the coiled cord. A plastic tie may be fastened around the device and the coiled cord along the length of the device. For example, a device positioned within a coiled cord 4 ft. or less in length may be fastened to the coiled cord at one or the other device ends. Alternatively, a device positioned within a coiled cord greater than 4 ft. in length may be fastened to the middle of the coiled cord at about the middle of device.

Referring to FIG. 2A, a device or COBRA™ positioned within a telephone cord less than 4 ft. in length and fastened thereto is illustrated. The telephone cord 200 is depicted in a U-shape and has connectors 210a,b, one of which plugs into a telephone handset and the other into a telephone base. The device or COBRA 220, has ends 230a,b, shown without the caps 120a,b as in FIG. 1 for simplicity. The COBRA™ is positioned within telephone cord 200, such that end 230a is proximate to connector 210a and are tied together by tie 240.

With continued reference to FIG. 2A, FIG. 2B illustrates the device or COBRA positioned within a telephone cord greater than 4 ft. in length. The telephone cord 205 is depicted in a U-shape, as with telephone cord 200, and has the connectors 210a,b at the ends thereof. COBRA 220 is positioned within telephone cord 205 such that ends 230a,b are equidistant from connectors 210a,b and appositionally positioned within the telephone cord 205. COBRA 220 is tied to telephone cord 205 by tie 240 at the midpoints of both.

The following examples are given for the purpose of illustrating various embodiments of the invention and are not meant to limit the present invention in any fashion.

### EXAMPLE 1

### COBRA Structure and Assembly

### O-Ring Cord

An O-ring cord has an outer diameter (OD) of 0.148 in. OD or 0.177 OD and length of about 16 in. to about 30 in. The vinyl caps have an inner diameter (ID) 0.148 in ID or 0.187 in ID and a length of about 3 or 4 in. Table 1 shows representative combinations of these dimensions and is not intended to be limited thereto.

TABLE 1

| Vinyl Caps (inches) | O-Ring Cord (inches) |
|---|---|
| ID 0.187 × 4 | OD 0.177 × 30 |
| ID 0.187 × 4 | OD 0.177 × 24 |
| ID 0.177 × 4 | OD 0.177 × 16 |
| ID 0.148 × 3 | OD 0.147 × 30 |
| ID 0.148 × 3 | OD 0.147 × 24 |
| ID 0.148 × 3 | OD 0.148 × 16 |

To assemble the O-ring cord depicted in FIG. 1, the O-ring cord is cut to a correct length, up to about 72 in., if desired. Two vinyl caps of about 2 to about 4 in. in length are selected and a drop of superglue is placed within in the inner diameter of each. Insert the O-ring cord ends into the inner diameter of each cap and let the glue set.

### Flat Cord

Vinyl caps are pre-attached at each end of a flat rubber cord. Vinyl caps may each be about 2 inches in length with diameters as described. The rubber cord may have a variable length as described with about a 0.25 in width and about a 0.125 in thickness.

### EXAMPLE 2

### Positioning the COBRA within a Coiled Telephone Cord

Phone Cord is 3 ft.

For a desk or wall mounted phone, as shown in FIG. 2A, insert the COBRA, either O-ring structure or flat structure, through the coils of the telephone cord at the phone case going to the receiver end. Stop about 2 inches before the COBRA end reaches the receiver in the phone. Optionally, tie the COBRA with a plastic tie to the telephone cord near the receiver end.

Phone Cord is 4 ft. or More

For wall mounted phones, mark the middle of the phone cord loop while the phone is hung-up. Find the middle of the COBRA. From the middle of the phone cord loop start inserting the COBRA, either O-ring structure or flat structure, half on one side and half on the other side of the phone cord loop. Make sure each end of the COBRA is the same height in the loop when the phone cord is hanging free. Optionally, tie the middle of the COBRA to the middle of the telephone cord loop with the plastic tie (FIG. 2B)

Any patents or publications mentioned in this specification are indicative of the level of those skilled in the art to which the invention pertains. Further, these patents and publications are incorporated by reference herein to the same extent as if each individual publication was specifically and individually incorporated by reference.

One skilled in the art would appreciate readily that the present invention is well adapted to carry out the objects and obtain the ends and advantages mentioned, as well as those objects, ends and advantages inherent herein. Changes therein and other uses which are encompassed within the spirit of the invention as defined by the scope of the claims will occur to those skilled in the art.

What is claimed is:

1. A device effective for preventing tangling of a coiled cord, comprising;
an elongate, flexible cord with dimensions less than the interior dimensions of the coiled cord and having a first and second end; and
means for rounding the first and second ends of the elongate, flexible cord.

2. The device of claim 1, wherein the elongate flexible cord is a flat cord or an O-ring cord.

3. The device of claim 1, wherein the elongate flexible cord comprises plastic tubing, a plastic rod, a rubber cord, or a steel wire.

4. The device of claim 1, wherein the elongate, flexible cord has a length of about 2 feet to about 6 feet.

5. The device of claim 1, wherein the means for rounding the ends of the elongate, flexible cord are rounded caps having an internal diameter sufficient to encase the first and second ends thereof.

6. The device of claim 5, wherein the caps are vinyl.

7. The device of claim 1, wherein the coiled cord is a telephone cord.

8. A device effective for preventing tangling of a coiled telephone cord, comprising:
an elongate, flexible cord with a first end and a second end and having a length and outer dimensions less than a length and internal diameter of the coiled telephone cord; and
rounded caps having an internal diameter sufficient to encase the first and second ends of the elongate, flexible cord.

9. The device of claim 8, wherein the elongate flexible cord is a flat cord or an O-ring cord.

10. The device of claim 8, wherein the elongate flexible cord comprises plastic tubing, a plastic rod, a rubber cord, or a steel wire.

11. The device of claim 8, wherein the elongate, flexible cord has a length of about 2 feet to about 6 feet.

12. The device of claim 8, wherein the caps are vinyl.

13. A system effective for preventing tangling of a coiled cord, comprising:
the device of claim 1; and
means for fastening the device to the coiled cord.

14. The system of claim 13, wherein the means for fastening is a plastic tie.

15. The system of claim 13, wherein the coiled cord is a telephone cord.
